(19) United States
(12) Patent Application Publication
(10) Pub. No.: US 2022/0327447 A1
(43) Pub. Date: Oct. 13, 2022

(54) CLIMATE-BASED RISK RATING

(71) Applicant: Climate Check, Inc., Tallahassee, FL (US)

(72) Inventors: Annie Preston, Berkeley, CA (US); Maximilian Stiefel, Salt Lake City, UT (US); Caleb Inman, Oakland, CA (US); Sam Eckhouse, Sanford, NC (US); Laura Elizabeth McGowan, Davis, CA (US)

(21) Appl. No.: 17/705,825

(22) Filed: Mar. 28, 2022

Related U.S. Application Data
(60) Provisional application No. 63/167,801, filed on Mar. 30, 2021.

(51) Int. Cl. G06Q 10/06

(52) U.S. Cl. CPC G06Q 10/0635

(57) ABSTRACT

A computer-implemented method and system for estimating a property-level climate risk rating based on a plurality of natural climate hazards (e.g., drought, heatwave, wildfire, storm, or flood). In some embodiments, the method includes providing or more computer processing devices programmed to perform operations including: calculating a relative change for a first natural climate hazard from a baseline to a target year; calculating a relative change for a second natural climate hazard from a baseline to a target year; normalizing each relative change; and determining an overall climate risk rating by averaging the climate risk rating of the first and second natural climate hazards.

### CROSS-REFERENCE TO RELATED APPLICATIONS

The present application claims the benefit of and priority to U.S. Provisional Patent Application No. 63/167,801 file on Mar. 30, 2021, which is incorporated in its entirety herein.

### FIELD OF THE INVENTION

The present invention relates to methods and systems for estimating future property-level risk to climate-sensitive natural hazards and more particularly, to provide estimates that are adapted to shift risk with projected climate change.

### BACKGROUND OF THE INVENTION

Climate change is altering the geography of natural hazard exposure across the world. For example, wildfire, floods, heatwaves, extreme storms, and drought hazard vary by areal extent (i.e., size of affected area), spatial patterning (i.e., dispersion and contiguity), frequency (e.g., rate of return), duration (e.g., length of event), and intensity (e.g., deviation from average conditions), which human activity moderates through climate and land use change. Moreover, human activity also moderates hazard severity (i.e., degree and type of impacts). Indeed, living in exposed areas, building faulty infrastructure, and limiting the quality and availability of institutional support often renders communities at higher climate risk (i.e., disaster probability and loss).

Current publicly-available climate risk estimates tend to be limited in their spatial, temporal, and assessment scope. This means estimates lack high enough spatial resolution, emphasize historical observations, and oversimplify risk, respectively, which leads to assessments that do not accurately capture the full range of property-level future risk. A good example of this are the Federal Emergency Management Agency's Flood Insurance Risk Management (FEMA FIRM) maps which provide categorical risk ratings across large-area polygons based on historical flood probability. Furthermore, publicly-available climate risk estimates are often inaccessible to the layperson, requiring scientific and engineering expertise to access, analyze, and interpret for consumer purposes.

The accuracy, precision, and spatiotemporal resolution of climate hazard estimation is improving. As the scientific fields supporting climate risk and impact assessment improve, our understanding of future risk becomes clearer. Flood risk has received some of the most substantial recent improvements in climate risk estimation. For example, new flood risk estimates, when compared to the FEMA FIRM standard for building code, placement, and insurance determinations, have found approximately three times as many people (i.e., from approximately 13 to approximately 41 million people) live in the 100-year floodplain.

However, these improvements often fall short in providing information in three ways: accessibility, intelligibility, and parsimony. For example, the information is typically hard to access at the property level, requiring users to find a platform to explore the specific climate risk and then navigate through geographic information systems. Even if the user succeeds in accessing information, understanding what the content represents is the next hurdle. Risk calculations typically represent loss probability and severity; but, comparing severity across climate hazards and different metrics is not straightforward. A user exploring fire risk might find two risk appraisals using different metrics to describe an event with one percent probability of occurring: the expected land area burned and the flame length. Comparing the effective risk of these metrics is practically impossible for an average user. Furthering that comparison across different outcomes of a climate hazard event, such as flood depth and land area burned, proves an even bigger challenge. Lastly, there are innumerable ways to represent climate risk. For the layperson just as for the scientist, a simpler risk model is often better. This is especially true since coping with climate risk is an inevitability. It is essential to distill only the most salient and impactful aspects of climate risk in any measurement tool.

### SUMMARY OF THE INVENTION

Methods and systems are described herein to estimate property-level climate risk and provide the general public with high spatial resolution climate estimates that are accessible, intelligible, and parsimonious. Moreover, an easily understandable, property-level, relative natural hazard risk rating to consumers is provided. This product is configured to synthesize scientifically rigorous data and methods across many fields, ranging from climatology, hydrology, geospatial engineering, and the like.

The present invention focuses on estimating natural hazard risks (i.e., climate hazards) that climate change projections suggest will or may shift over the next several decades. To assess risk from these climate hazards, diverse datasets are integrated from relevant units of analysis, representing myriad natural and social phenomena, to comparable spatiotemporal scale.

Modeled projections come from tens of internationally accepted global climate models that have been validated as part of the Coupled Model Intercomparison Project Phases (CMIP) 5 and 6. When available for CMIP 5, output for Representative Concentration Pathways 4.5 and 8.5 (RCP4.5 and 8.5) may be selected. These represent intermediate worst-case scenarios, respectively, for the continued release of CO₂ into the atmosphere. When available for CMIP6, output for Shared Socioeconomic Pathway (SSP) 2-4.5 and 5-8.5 may be selected. SSPs represent models of development for projected socioeconomic systems such as “sustainability” and “fossil fuel development.” Researchers have downscaled these coarse General Circulation Model (GCM) projections to higher resolution across the United States by utilizing local information (e.g., weather patterns, vegetation, hydrodynamics, topography, and so forth) and leveraging the empirical links between climate at large scales and then at finer scales.

Future climate hazard estimates with the relative change in hazard from baseline using modeled projections and historical observations may then be weighed. This weighted hazard estimate—the combination of future hazard and how much the hazard will change over time—serves as the value that can be transformed into a relative 0-100 rating scale based on empirical evidence and scientific knowledge. The overall climate risk rating becomes the average of the risk ratings across all five climate hazards: Heat, Storm, Wildfire, Drought, and Flood. In the case where two properties have similar climate hazard characteristics but different projected changes, the property with a more dramatic increase in hazardous conditions may be given a higher risk rating. This reflects the challenges and cost of adjusting to climate change and the increased stress on local infrastructure. Baseline risk estimates stretching as far back as the mid-1900s and downscaled future projections work together to produce high spatiotemporal resolution estimates and predictions of how climate risk will change over the 21^{st} century.

In a first aspect, a computer-implemented method for estimating a property-level climate risk rating based on a plurality of natural climate hazards (e.g., drought, heatwave, wildfire, storm, or flood) is described. In some embodiments, the method includes providing one or more computer processing devices programmed to perform operations including: calculating a relative change for a first natural climate hazard from a baseline to a target year; calculating a relative change for a second natural climate hazard from a baseline to a target year; normalizing each relative change; and determining an overall climate risk rating by averaging the climate risk rating of the first and second natural climate hazards. In some variations, normalizing each relative change includes z-score standardizing a relative change distribution per target year and/or separating z-scores into a first group that includes non-standardized positive values and into a second group that includes non-standardized negative values.

In further implementations, the method may include one or more of: calculating a relative change for one or more additional natural climate hazards from a baseline to a target year and determining an overall climate risk rating by averaging the climate risk rating of the first, second, and one or more additional natural climate hazards; weighting a projected average in each target year (e.g., by using a normalized relative change); and/or map weighting a projected average for each target year to a cumulative function of a year 2050 weighted projected average.

In some variations, either the first or the second natural hazard comprises drought, the method further includes aggregating HUC-8 boundaries when the HUC-8 boundaries cross one another at a location.

In a second aspect, a system for estimating a property-level climate risk rating based on a plurality of natural climate hazards (e.g., drought, heatwave, wildfire, storm, or flood) is described. In some embodiments, the system includes a communication network, a plurality of databases adapted to communicate via the communication network, and one or more computer processing devices adapted to communicate via the communication network. In some implementations, the computer processing devices are programmed to perform operations including: calculating a relative change for a first natural climate hazard from a baseline to a target year; calculating a relative change for a second natural climate hazard from a baseline to a target year; normalizing each relative change; and determining an overall climate risk rating by averaging the climate risk rating of the first and second natural climate hazards. In some variations, normalizing each relative change includes z-score standardizing a relative change distribution per target year and/or separating z-scores into a first group that includes non-standardized positive values and into a second group that includes non-standardized negative values.

In further implementations, the computer processing devices of the system may be programmed to calculate a relative change for one or more additional natural climate hazards from a baseline to a target year and determining an overall climate risk rating by averaging the climate risk rating of the first, second, and one or more additional natural climate hazards; weight a projected average in each target year (e.g., by using a normalized relative change); and/or map weight a projected average for each target year to a cumulative function of a year 2050 weighted projected average.

In some variations in which either the first or the second natural hazard includes drought, the method further includes aggregating HUC-8 boundaries when the HUC-8 boundaries cross one another at a location.

In a third aspect, an article for estimating a property-level climate risk rating based on a plurality of natural climate hazards (e.g., drought, heatwave, wildfire, storm, or flood) is described. In some embodiments, the article includes a non-transitory computer-readable medium having instructions stored thereon that, when executed by one or more computer processors, cause the computer processors to perform operations that include: calculating a relative change for a first natural climate hazard from a baseline to a target year; calculating a relative change for a second natural climate hazard from a baseline to a target year; normalizing each relative change; and determining an overall climate risk rating by averaging the climate risk rating of the first and second natural climate hazards. In some variations, normalizing each relative change includes z-score standardizing a relative change distribution per target year and/or separating z-scores into a first group that includes non-standardized positive values and into a second group that includes non-standardized negative values.

### BRIEF DESCRIPTION OF THE DRAWINGS

In the drawings, like reference characters generally refer to the same parts throughout the different views. For the purposes of clarity, not every component may be labeled in every drawing. Also, the drawings are not necessarily to scale, emphasis instead generally being placed upon illustrating the principles of the invention. In the following description, various embodiments of the present invention are described with reference to the following drawings, in which:

FIG. 1 shows a system for estimating a property-level climate risk rating based on a plurality of climate hazards, in accordance with some embodiments of the present invention.

### DETAILED DESCRIPTION

In a first aspect, the present invention provides a method for calculating the relative change from baseline to target future year, normalizing the relative change, weighting the projected average in target year by a normalized relative change, and map weighted projected averages for each target year to the cumulative distribution function of the (Year) 2050 weighted projected average. This results in a final risk rating from 0 to 100 that is relative to other cells and to the year 2050, which is within the standard thirty year mortgage term. Properties in areas with a higher risk increase will have relatively higher risk ratings.

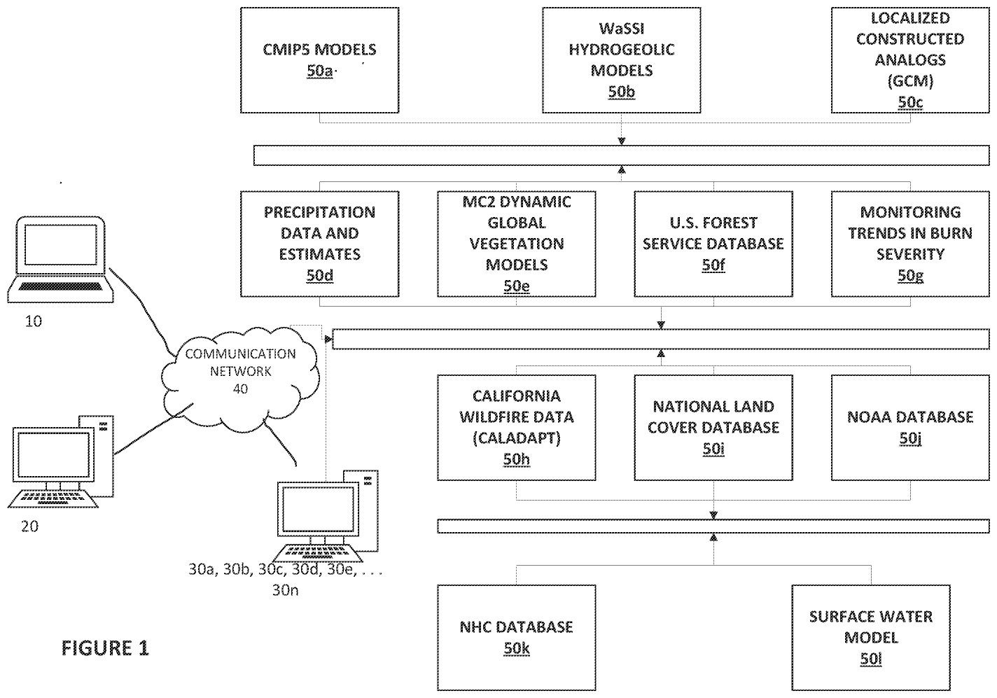

Referring to FIG. 1, in a first step, the system calculates relative change. For example, in some embodiments, the system takes the relative change from baseline to target year and truncates the distribution per target year by the minimum value of either two (2) standard deviations (σ) above or the 90^{th} quantile. Let projected values of ēₜ or k̅ₜ be v and let baseline values be b. The percent change (rₜ) of projected average values v (count or proportion averages) from baseline b for unit i in years t=2020, 2030, . . . 2060 may be given by the equation:

$${r}_{t} = \frac{{v}_{i}^{t} - {b}_{i}^{t}}{{b}_{i}^{t}} \qquad EQN . 1$$

In a next step, the relative change distribution per target year may be normalized. More specifically, the relative change distribution per target year may be z-score standardized by the mean (μ) and standard deviation (σ) of the 2050 relative change distribution. For example, these z-scores may be separated into two groups: non-standardized positive and non-standardized negative values. Each group may be min-max normalized separately using, for example, the minimum and maximum z-scores from the 2050 distribution. Omitting non-standardized values equal to zero (0) during this process and reintroducing after. The result may include positive relative change values between about 1 and about 1.5, negative values between about 0.5 and about 1, and zero values of 1. Target years beyond 2050 may exhibit maximum values over 1.5.

Transforming percent change (rᵢ^{t}) may require z-score standardizing the (Year) 2050 percent change r²⁰⁵⁰ using, for example, the equation:

$${z}_{i}^{2050} = \frac{{r}_{i}^{2050} - {μ}^{2050}}{{σ}^{2050}} \qquad EQN . 2$$

from which the maximum and minimum values of positive and negative sides of the percent change values the 2050 z-score may be determined using, for example:
(zᵢ²⁰⁵⁰)s.t.rᵢ²⁰⁵⁰>0
(zᵢ²⁰⁵⁰)s.t.rᵢ²⁰⁵⁰>0
(zᵢ²⁰⁵⁰)s.t.rᵢ²⁰⁵⁰<0
(zᵢ²⁰⁵⁰)s.t.rᵢ²⁰⁵⁰<0

Furthermore, percent change values may be z-score standardized by target year using the mean and standard deviation of the (Year) 2050 percent change distribution, for example, using the equation:

$${z}_{i}^{t} = \frac{{r}_{i}^{t} - {μ}^{2050}}{{σ}^{2050}} \qquad EQN . 3$$

from which minimum and maximum normalized z-scores for each target year (zᵢ^{t}) for all positive percent change values (+zᵢt) using, for example, the minimum and maximum values from the (Year) 2050 z-scores (zᵢ²⁰⁵⁰).

Using the following equation, min/max z-scores may be normalized for each target year, z^{t}. Such normalization may occur for all positive percent change values (+r^{t}) using the minimum and maximum from the 2050 z-scores, z²⁰⁵⁰, as well as for all negative percent change values (−r^{t}):

$$\begin{matrix}1 + \frac{{z}_{i}^{t} - min ( {z}_{i}^{2050} )}{max ( {z}_{i}^{2050} ) - min ( {z}_{i}^{2050} )} & if {r}_{i}^{t} > 0 \\ {z}_{i}^{′t} = 0.5 + \frac{{z}_{i}^{t} - min ( {z}_{i}^{2050} )}{max ( {z}_{i}^{2050} ) - min ( {z}_{i}^{2050} )} & if {r}_{i}^{t} < 0 \\ 1 & otherwise\end{matrix}$$

The projected average (vᵢ^{t}) may be multiplied by the normal-standard percent change (zᵢ⁰^{ₜ}) to provide a weight-projected average by normalized relative change using the equation:

wᵢ^{t}=zᵢ⁰^{ₜ}*vᵢ^{t} EQN. 5

In a next step, weighted projected averages to the (Year) 2050 distribution may be transformed. For example, the target year weighted projected averages may be transformed onto the cumulative distribution function of the 2050 weighted projected average, which returns a probability. When the returned probability is multiplied by the value of 100, risk scores in the range of 0 to 100 may be obtained. Advantageously, this approach makes scores from any target year relative to values of the (Year) 2050 distribution. For example, using mock statistics, if the weighted projected average of (Year) 2030 had a mean of 20 and a standard deviation of 12 and in (Year) 2050 had a mean of 25 and a standard deviation of 13, a risk rating value of 18 from 2030 would take a score of approximately 43 without transformation and a score of approximately 30 with transformation.

In a next step, the weighted average (wᵢ^{t}) may be transformed with the cumulative distribution function (Fₓ(x)) of the weighted average of (Year) 2050 (wᵢ²⁰⁵⁰) and the result may be multiplied by 100 to obtain a risk estimate(s) (sᵢ^{t}), ranging from 0 to 100. In short:

F_{V}²⁰⁵⁰(Vᵢ^{t})=P(V²⁰⁵⁰≤v^{t})*sᵢ^{t}=P(V²⁰⁵⁰≤vᵢ^{t})*100 EQN. 6

The type of data used to produce the risk rating may vary according to the nature of the climate hazard(s). For example, Table 1 provides exemplary metadata for various climate hazards, including the nature of the hazard, its periodicity, projected and baseline dates, and so forth.

TABLE 1
Climate Hazard Metadata

| | | | | Avg. | | |
|---|---|---|---|---|---|---|
| Hazard | Periodicity | Baseline | Projected | Range | Geography | |
| drought | annual | 2011-2030 | 2011-2070 | 20 | HUC-8 | |
| extreme heat | annual | 1981-2005 | 2016-2065 | 10 | 5 | km² |
| extreme precip. | annual | 1981-2005 | 2016-2065 | 10 | 5 | km² |
| extreme wind | annual | 1981-2005 | 2016-2065 | 30 | 25 | km² |
| wildfire | annual | 1953-2002 | 1991-2090 | 60 | 30 | m² |
| high tide flood | decadal | 2010 | 2020-2060 | 1 | 10 | m² |
| storm surge flood | two points | 1900-2000 | 2050 | 1 | 10 | m² |
| fluvial flood | two points | 1971-2000 | 2036-2065 | 1 | 10 | m² |
| pluvial flood | two points | 1971-2000 | 2036-2065 | 1 | 10 | m² |

Indeed, extreme event frequencies and magnitudes may be used for heat, wind, storm, wildfire, and flood hazards; burn probabilities may be used for wildfire; and an index may be used for drought. For example, storm surge, high tide, fluvial flood, and pluvial flood hazard, which data may be used in connection with flood risk rating, rely on the probabilistic relationship between flood depth and return interval. These hazard estimates may be supplemented with additional data sources depending on the climate hazard.

As shown in Table 1, for the risk associated with drought (i.e., water scarcity), in some implementations, the risk rating may be based, for example, on the Water Supply Stress Index (WaSSI) hydrologic model, which measures how much available water in a location is used by human activity. WaSSI is specific to each watershed, i.e., a lane area with the same water outlet. The geographic unit of analysis is USGS hydrologic designation HUC-8, the sub-basin level, which is analogous to medium-sized river basins. WaSSI takes into account current and projected water supply; surface and groundwater; demand due to population size and water use; and features of the watershed, such as soil properties and land cover. The underlying analysis may use downscaled data from, for example, CMIP5 climate models under the RCP8.5 scenario as inputs. These data come as annual water demand and supply estimates in cubic meters, output using an ensemble of 20 climate models. Projections may be based on trends in the climate, demographics, and uses (such as irrigation and thermoelectric power).

In some applications, WaSSI may be calculated using the ratio of water demand to water supply within a watershed. The model considers demand as water withdrawal and consumption for, inter alia, domestic, thermoelectric, and irrigation purposes. Supply is local and equal to upstream water flow minus upstream consumption plus interbasin transfers (places where water sourced from one area is used in another). Water stress may be measured within the local watershed, which is the land area that channels natural water supply to a property. This watershed does not necessarily account for a water provider's strategies to overcome water stress such as through aqueducts and other infrastructure. A WaSSI value above 1 indicates that water demand is higher than water supply. The higher the WaSSI the higher the water stress. In some variations, WaSSI may be averaged in five-year intervals from, for example, 2020 to 2060, with a sliding window around each target year. In some instances, a twenty-year window may be used for baseline and projected WaSSI and all average values may be trimmed to the 95^{th} percentile to remove any outliers.

The WaSSI model presents an issue for watersheds adjacent to the Great Lakes. Indeed, the model does not consider sourcing from the Great Lakes as a flow or an interbasin transfer. Consequently, the WaSSI for these watersheds, typically, may be artificially inflated if based solely on the demand/supply ratio. An alternative solution stems from the Great Lakes-St. Lawrence River Basin Water Resource Council, an interstate and international body that oversees use of surface freshwater according to a 2008 compact. The compact stipulates that water supply should be analyzed at the basin scale rather than the watershed since the Lakes serve as transfers, thus making the Great Lakes one resource pool for adjacent watersheds. Accordingly, Great Lakes-adjacent watershed supply and demand may be aggregated to calculate a basin-scale WaSSI.

Only incorporating HUC8s in the Great Lakes basin leaves the remaining problem of boundary discontinuities, e.g., drastically different WaSSI in adjacent HUC-8, one which is in the Great Lakes Basin and the other which is not. This is particularly problematic when HUC-8 boundaries cross through metropolitan areas, such as Chicago, which contains two hydrologic regions: the Great Lakes and the Upper Mississippi. To adjust for this issue, the HUC-8s in the Great Lakes Basin, as well as the HUC-8s adjacent to the basin, may be aggregated. WaSSIs in the aggregated HUC-8s may be weighted annually, e.g., using their normalized water demand, so that every HUC-8 in the set does not have the exact same WaSSI.

Typically, a risk rating may be determined by mapping weighted projected averages onto the 2050 weighted projected average cumulative distribution function. Sometimes this mapping produces biased risk ratings. In these cases, stepped min/max transformations may be used to produce the risk rating. Advantageously, the stepped min/max transformation normalizes weighted projected averages in bins. For each bin, the range represented in the transformation may be established based on scientific and/or empirical evidence. For example, with WaSSI, four bins may be created: low water stress, moderate water stress, high water stress, and demand higher than supply. These bins have both empirical and theoretical bases. For example, low water stress comprises the majority of watersheds, moderate water stress is the range between the majority and the point at which water stress becomes a pressing issue for a community. Watersheds at this point, high water stress, and beyond face infrastructural, economic, and quality of life challenges. Once demand exceeds supply, more drastic actions must be taken to ensure sufficient water otherwise catastrophic outcomes may ensue.

Climate models project extreme heat, precipitation, and wind events to change globally. Thus, projected changes and extreme events may be estimated using, for example, Localized Constructed Analogs for heat and precipitations, i.e., GCM output that has been enriched for statistical downscaling to a higher geographic resolution. Downscaled projections better match local conditions at a higher 5 km² resolution. These data come as modeled daily meteorological phenomena-maximum temperature and precipitation observations in degrees Celsius (° C.) and millimeters (mm), respectively, from 1980-2065 for 210,690 longitude/latitude pairs.

Downscaled projections for extreme wind may, in some implementations, come from National Center for Atmospheric Research (NCAR) state-of-the-art, dynamically downscaled datasets that better capture convective meteorological processes. Two projections from the North American Regional Climate Change Assessment Program (NARCCAP) at a 50 km² spatial resolution and one from the North American Coordinated Regional Climate Downscaling Experiment (NACORDEX) 25 km² resolution may also be used.

The present system is, in some embodiments, configured to conduct all statistical estimates, e.g., annual extreme counts, per GCM model and then to average across 27 GCMs from the CMIP. Precipitation estimates may be based on the annual average counts of extremely wet (or snowy) two-day storms and the annual average amount of precipitation that may fall during those storms. Heat estimates may be based on annual average counts of extremely hot days and the typical temperature magnitude of those days. For wind, extreme return periods and levels may be estimated from extreme probability distributions to account for extreme wind events that occur outside the available data constraints.

Extreme is defined as values in the top or bottom percentile of a weather variable distribution. A threshold value represents the numerical cutoff for extreme values, which we find with the 98^{th} percentile of all values for each longitude/latitude pair (i.e., “cell”) during the historic baseline, from 1981-2005. The present system is adapted to use threshold values to estimate at the cell level for heat and storm risk estimates, but for other risk estimates we might utilize other threshold conformations, such as at the regional or national level. To find threshold values by geographic unit (cell), all values measured in a cell during the baseline period may be used; for the administrative unit (region) threshold values by region may be averaged across cells; and for the whole national dataset (global) the sample average of threshold values, i.e., across all cells, may be used. To produce any threshold conformation, estimates may be averaged across the relevant components (cell, region, and global). These alternative conformations can be desirable to increase local variation, produce regionalization, and maintain comparability across cells. Thresholds may be estimated for all values in the baseline estimation range. If, on average, more days exceed this baseline threshold in 2050, then an increase in extreme events is observed.

We find thresholds for values X in cell i at F_{X}(x)=0.98 to obtain hᵢ. The state threshold may be evaluated by taking all cell threshold values hᵢ by state j:

$${\overline{h}}_{j} = \frac{1}{N} {\sum }_{i = 1}^{N} {h}_{i j} \qquad EQN . 7$$

for j=1, . . . , 48 states. The global threshold is equivalent to:

$$\overline{h} = \frac{1}{N} {\sum }_{i = 1}^{N} {h}_{i} \qquad EQN . 8$$

A composite threshold ch for cell i is the average value among the cell, region (e.g., state), and global thresholds may be estimated using the equation:

$$c {h}_{i} = \frac{1}{N} {\sum }_{i = 1}^{N} ( {h}_{i} , {\overline{h}}_{j} , \overline{h} ) \qquad EQN . 9$$

For example, the system may be adapted to count how many days annually exceed the threshold. This may be done for the target estimation range at baseline, as well as in the future. The number of values that exceed the threshold per longitude/latitude pair may be summed and divided by the year length of the estimation range. The number of extreme events e for cell i at year t, where extreme is any value x beyond threshold chᵢ and average over time around each target year may be counted using the equation:

$${e}_{i}^{t} = {\sum }_{i = 1}^{N} {x}_{i}^{t} ∀ {x}_{i}^{t} \geq c {h}_{i} {\overline{e}}_{t} = \frac{1}{N} {\sum }_{i = 1}^{N} {e}_{i}^{t} \qquad EQN . 10$$

In some embodiments, for the risk rating relating to storms, the number of two-day precipitation events that exceed the 98^{th} percentile threshold (which may be calculated using two-day totals relative to the cell over the baseline period) may be counted. The difference between counts of days and counts of events is, for example, an extreme event that lasts three consecutive days would have a value of three days and two events. Counting the amount of precipitation that occurs over at least a two-day period is important because the phenomenon is not diurnal and the cumulative effects of extreme precipitation are of primary concern. The total precipitation value (i.e., the sum precipitation that occurred on days quantified as part of an extreme precipitation event) may also be used for the storm risk rating.

For risk rating associated with wildfire hazards, wildfire risk may be estimated using extreme fire weather frequency and magnitude extent and return interval (i.e., fire weather index), intensity (i.e., flame length exceedance probability), and severity (i.e., conditional risk to potential structures). The first two parameters estimated from extreme values of the fire weather index may be based, in some embodiments, on the Fire Weather Index (FWI): a wildfire danger rating system metric that combines temperature, precipitation, relative humidity and wind speed. FWI is a daily measure of fire danger with 4 km spatial resolution that accounts for the effects of fuel moisture and wind on fire behavior and spread. It uses downscaled data from an ensemble of 20 CMIP GCMs. This FWI estimation represents how often extremely dangerous fire weather may occur in the future and how much more extreme it may be.

The other two parameters may be derived, in some applications, from higher resolution U.S. Forest Service (USFS) data products static to 2020. Intensity represents the likelihood that flame length exceeds four feet if a fire were to occur, while severity represents the risk posed to a hypothetical structure if a fire occurred. Taking the change in wildfire danger estimated over future time from FWI and integrating it with USFS products representing wildfire likelihood, intensity, and severity. The integrated product is at a sufficiently high 30 m² spatial resolution to assess risk based on the environmental context for a specific property. A wildfire risk rating may be estimated using the weighted geometric average of relative ranked values for these statistics. In some variations, the weighting may include 0.5 for extreme FWI frequency and magnitude, 0.25 for intensity, and 0.25 severity.

These wildfire risk estimates may be further enhanced using observed Western U.S. fire occurrence from the Monitoring Trends in Burn Severity (“MTBS”) remotely sensed data product and localized improvements in quality, resolution, and coverage, such as probabilistic wildfire projections for California's Fourth Climate Change Assessment. Typically, the system is adapted to average across estimates from different datasets that cover the same time and place. However, when spatiotemporal resolutions are misaligned or very coarse, the system may select a maximum value(s) across datasets to represent the absolute wildfire burn probability. A mask may be applied to the result to reduce the risk estimate in cells representing non-vegetated land and the presence of human activity, such as agriculture and densely built environments, which lower the risk of wildfire.

Any data product involving future risk, i.e., accounting for climate change in projected time, is available as output for each GCM used as an input. These GCMs have been rigorously tested by the CMIP5. The system may be structured and arranged to average across all available GCMs to reduce bias and produce more robust risk estimates. Those of ordinary skill in the art can appreciate that the climate risk estimate depends, in part, on the step at which models are averaged across. For example, for wildfire risk, the GCMs may be averaged across after estimating extreme FWI count frequencies and magnitudes. Consequently, the FWI hazard estimates are the multi-model averages of extreme events.

The proportion burned per cell may be averaged over a sixty year period at baseline and in the future. For example, the areal affected surface (l) and find the proportionality (k) may be averaged for cell i at year t according to the equation:

$${k}_{i}^{t} = \frac{{l}_{i}^{t}}{A} \qquad EQN . 11$$

where A is the area of a cell in the dataset and average (k̅ₜ) over time around each target year according to the equation:

$${\overline{k}}_{t} = \frac{1}{N} {\sum }_{i = 1}^{N} {k}_{i}^{t} \qquad EQN . 12$$

In some implementations, the system may also incorporate an additional source of modeled California wildfire data from CalAdapt. For example, proportions for the CalAdapt data may be calculated to match the value type in our MC2 data. The CalAdapt data come in hectares burned per cell, which may be converted to proportions by dividing each value by the maximum possible burned hectares per cell. The system may then align the extent and resolution of the CalAdapt data to the MC2 data and determine and average between the two datasets. In some variations, values in the projected range with any higher value from the MTBS data may be replaced with an observed fire history dataset that only captures larger fires, i.e., those over 1000 acres. After integrating additional data sources, baseline and future averages may be recalculated. Future averages are in five-year intervals with a sliding window around each target year. In some applications, a sixty year window for baseline and projected proportion burned averages may be used.

The system may produce the wildfire risk rating using an alternative stepped min/max transformation. The alternative stepped min/max transformation normalizes weighted projected averages in bins. For each bin, the range represented in the transformation may be manually or automatically set based on scientific and empirical evidence. For example, with extreme wildfire hazard, more weight may be placed on the top third of the distribution since the probability of property loss and air quality degradation, among other impacts, increases more quickly the larger the fire becomes. This is because of the positive feedback loops and the diminishing returns of fire-fighting efforts involved in large fire escalation.

The extreme FWI counts represent a best estimate of how projected climate change may shape wildfire hazard characteristics throughout the next few decades. However, these data are at too coarse a spatial resolution for property-level risk assessment and do not explicitly factor in how intense a fire may become based on vegetation (i.e., energy released) nor the severity of impacts (i.e., as measured in property loss). To capture these components, in some variations, U.S. Forest Service data products for intensity (i.e., flame length exceedance probability) and severity (i.e., conditional risk to potential structures) may be incorporated into the estimate. Both of these products rely on a preliminary burn probability and supplementary data, such as vegetation, structures, and terrain. The system provides a wildfire risk rating from the weighted geometric average of relative ranked values for these statistics. In some embodiments, the weighting may be 0.5 for areal extent and return interval, 0.25 for intensity, and 0.25 for severity.

In some applications, to mask out land that is either barren or dominated by human activity (e.g., urban centers, agriculture, and the like) the National Land Cover Database (NLCD) may be used. When used, the NLCD may be reclassified to a binary surface: burnable or non-burnable. USFS products (e.g., CRPS, FLEP4, and so forth) may then be masked and the projected proportion burned data resampled to the same resolution as the USFS products (i.e., 30 m²). With the three layers (i.e., FWI, CRPS, and FLEP4) at the same resolution and numerical range, the geometric average may be weighted, for example, as 0.5 for FWI, 0.25 for CRPS, and 0.25 for FLEP4 in calculating a final wildfire risk rating.

Flood (pluvial, fluvial, high tide, and storm surge) risk may be estimated as a combination of several types of flooding: storm surge, high tide, and precipitation-based flooding. Storm surge and high tide flooding only occur in coastal areas, whereas precipitation-based flooding may occur anywhere and generally represents two distinct types: overflowing river waters (i.e., fluvial) and surface water flooding (i.e., pluvial). Pluvial and fluvial flooding may be estimated together using separate sources of expected depth by probability data. The risk estimate is the occurrence probability and likely depth of a significant flood between 2020 and 2050 across all four types of flooding.

In some implementations, each type of flood risk may be estimated independently and a marginal cumulative sum of the three risk types may be calculated. One advantage of this approach is that it may account for more extreme flood risk and for accumulation of any-type flooding; however, it does not discount for lower or non-existent any-type flooding. For example, we observe a combined flood risk rating of 87.5 if risk across the three types is each 50; a combined flood risk rating of 90.625 if risk is 25, 50, and 75 across three types; and a combined flood risk rating 96 if risk is 0, 80, and 80 across three types. a combined flood risk rating

High-tide coastal flooding occurs when water inundates land during the highest tides. It is a cyclically-occurring phenomenon where coastal waters exceed mean higher high water (MHHW), the average height of the highest tide recorded each day. The land above MHHW is dry most of the time. MHHW has a baseline average from the most recent National Tidal Datum Epoch from 1983-2001 and varies locally by relative sea level, tidal patterns and behavior, and geomorphological features and processes, such as elevation and coastal erosion. Similarly, high-tide flooding probability is a function of local relative sea level and elevation. As the planet warms, sea levels rise due to melting ice and warming water, which takes up more space than cooler water, increasing ocean volume. Sea level is rising globally but varies locally.

In some embodiments, National Oceanic and Atmospheric Administration (NOAA) data and modeling products (e.g., daily observed tidal variability measured at tide gauges, 50 m² mean higher high water interpolated surface data, 10 m² digital elevation models, relative seal level rise projections, and the like) may be used to calculate the risk rating. First, established coastal flooding models may be used to quantify the typical range of high tide heights for a location and the associated inundation. Forecasts of local sea level rise through 2050 may be estimated to augment these tide heights and estimate how much land may be inundated in the future.

The 16 MHHW tiles provide a 50 to 100 m² horizontal resolution. Sea level rise projections come as a one-degree grid along the coasts. Daily tidal data is from nearly 100 tidal gauges. There are about 77 DEMs at about 3 to 5 m² horizontal resolution with vertical resolution in centimeters. Several geoprocessing tasks may be conducted on these DEMs: first to remove hydrographic features, then to resample to a 10 m² resolution, and lastly remove elevations above 10m. The DEM may be vectorized and elevation converted to centimeters.

Several nearest neighbor exercises may be performed on each elevation grid cell using a simple spatial k tree. For example, the nearest Mean Higher High Water (MHHW), the average height of the highest daily tide recorded during the 1983-2001 tidal epoch, using, for example, a 50-100 m grid, may be identified. Using, e.g., one-degree gridded coastal sea level rise projections, the system can interpolate nearest relative sea level to year 2000 and a localized reference land level (MHHW). Inverse distance weighted averages may be calculated between the two nearest values.

The nearest tidal gauge to each elevation grid cell may then be identified. The daily high-tide distribution from the closest tidal gauge may then be used to model exceedance probabilities. Finally, an interpolated MHHW from the elevation value for every cell may be differenced out. Those skilled in the art can appreciate that the last step may be conducted independently on each DEM tile. Another nearest neighbor matching may be conducted: this time for tidal sensors and the sea level grid. Advantageously, non-parametric probability density estimation may be used to produce theoretical high-tide flooding probability density functions with the maximum daily tidal distributions and shift by projected sea level rise in ten-year time steps. The probability density functions may then be applied to elevation values to produce high-tide flooding probability estimates, which estimates represent a high-tide flood risk rating (i.e., the daily probability of high tide flooding). The probability may be multiplied by 365 to estimate the expected annual number of high-tide flooding days.

Although the high-tide flood risk rating is numerically complete, geospatial cleaning may be necessary. For example, cells representing zero risk, hydrographic features, and cells with risk larger than 0 but disconnected from the sea may be removed. The risk rating may also be converted back to raster and reclassified as binary, 1 for scores greater than or equal to 1 and 0 for scores under 1. Region grouping may also be performed to remove low elevation cells not connected to the sea. All hydrographic and zero risk cells may also be removed to arrive at the final spatial subset of cells that we include in a risk rating.

A storm surge is a rise in ocean water, higher than any normal tide, generated by a storm. Storm surges typically occur when extreme storm winds push water toward the shore. The depth of the resulting flood depends on the strength of the storm and its direction, as well the shape of the coastline and local terrain. NOAA and the National Hurricane Center (NHC) models that estimate the worst-case scenario flood depth at a 10 m² resolution along the Atlantic and Gulf coasts for each category of hurricane can be used for risk rating. To quantify the likelihood of these floods, the system uses observed hurricane tracks between 1900-2000 to measure how frequently Category 1-5 storms pass within about 50 miles of a location.

Fluvial flooding and pluvial flooding occur when natural and artificial hydrologic systems become overwhelmed with water. The flooding that occurs can rush over the land surface and quickly drain following the event, such as during a flash flood, or can quickly build up and persist for days and weeks. These types of flooding occur in both coastal and inland areas. Fluvial, or riverine, flooding happens when a river or body of water overflows onto surrounding land. Pluvial, or rain-fed, events occur when extreme rainfall creates flash flooding or surface water buildup away from a body of water.

To quantify present and future risks due to fluvial or pluvial flooding, a surface water model, e.g., the Weighted Cellular Automata 2D (WCA2D) model or the like, may be used. Current (2020) flood risk may be established using historical meteorological observations to feed models of rainfall and runoff that capture flooding behavior across the United States. In some embodiments, flood hazard in 2050 may be modeled using CMIP 5 and 6 GCM ensemble described above under the scenarios of RCP 4.5 and 8.5 of SSP 2-4.5 and 5-8.5, respectively.

Different return intervals, e.g., from 1 in 5 years to 1 in 500 years, i.e., annual probabilities of 20% and 0.2%, respectively, may be estimated. The horizontal resolution is 10 m² and the vertical resolution of flood depth in centimeters. The fluvial and pluvial flood depth may be estimated per return interval by taking the maximum value between the two tiles and the two estimated depths may be combined. Using the combined depth estimates, expected occurrence probability and likely depth of a flood between 2020 and 2050 per interval may be evaluated to arrive at annual depth: the statistic used to produce the precipitation-based component of flood risk rating.

The WCA2D model, which is part of the CADDIES framework, is an open-source hydraulic model for rapid pluvial simulations over large domains. WCA2D is a diffusive-like cellular automata-based model that minimizes the computational cost usually associated with solving the shallow water equations while yielding comparable simulation results in terms of maximum predicted water depths.

Topographic data, in the form of gridded elevation data used to produce a Digital Elevation Model (DEM), are the single most important control on the performance of any flood hazard model. In this regard, the U.S. is better served than most other countries around the world because the USGS makes publicly available The National Map 3DEP from the National Elevation Dataset, which is predominantly LIDAR based in urban areas. Both 1 arcsecond and ⅓ arcsecond DEMs may be used for hydraulic model execution and downscaling, respectively.

Running the WCA2D model to estimate pluvial flood depths and extent using the effective precipitation total from a 6 hour precipitation event for a given return period and the 1 arcsecond (˜30 m) DEM. These terrain data come unprojected in geographic latitude/longitude. These data may then be projected onto NAD83 Albers equal area coordinate reference system as the WCA2D model requires projected terrain data.

To calculate the effective precipitation, three types of input data may be used: land cover, soil types, and intensity-duration-frequency curves. The 2016 NLCD helps identify urban areas where soil data are not appropriate for infiltration estimates due to the presence of artificial impervious surfaces and storm drain networks. NOAA Intensity-Duration-Frequency curves (IDF) describe the relationship between the intensity of precipitation, the duration over which that intensity is sustained, and the frequency with which a precipitation event of that intensity and duration is expected to occur. The general pattern is that the longer the duration, the rarer the occurrence of a given intensity. However, factors such as local climatology and elevation may influence the nature of these relationships. In the U.S., NOAA produces digitized gridded IDF data that cover a range of durations and return periods for the entire country. These curves represent total precipitation accumulation in millimeters.

Return intervals represent flood events typically used for scientific and planning purposes. A 1 in 100 return interval is based on a precipitation event likely to occur once every 100 years, i.e., an event that has an annual probability of 0.01 and a daily probability of 0.00001369863014. Thus, extreme precipitation events may be estimated for the 1 in 100 and 1 in 500 return intervals. The inverse daily probability may then be used to find the precipitation exceedance threshold for each grid cell associated with a given return interval using all days in the sample, (n=350656), i.e., all days across all years in the period, pooled across all models. Changes in event magnitude may be assessed as relative differences in the precipitation value associated with the return interval. The baseline period is 1971 to 2000 and the projected period is 2036 to 2065. Historic IDF curves may be adjusted, for example, using the relative change in event magnitude to produce projected IDF curves. Input precipitation for any flood model derives from these 2020 and 2050 IDF curves.

When precipitation hits most types of land surface, some of it will infiltrate and the rest of it will flow across the surface as surface runoff. The ability of a particular type of land surface to absorb water is known as infiltration capacity, and this capacity varies with both soil type (sand, loam, clay, etc.) and with how much water the soil is currently holding. Typically, soils with large particles (such as sand) can sustain higher infiltration rates than soils with very fine particles (clay), whilst dry soils have a higher infiltration capacity than saturated soils. It follows, therefore, that the rate at which a particular type of soil can absorb water changes during a precipitation event as the moisture content of the soil steadily increases to the point of saturation.

The U.S. Department of Agriculture (USDA), in conjunction with other Federal agencies, maintains a national spatial database of soil types and characteristics called the Soil Survey Geographic Database (SSURGO), which contains a field called Hydrologic Group-Dominant Conditions (hydgrpdcd). There are a further three subgroups (A/D, B/D, C/D) representing soils that would normally be in groups A, B, or C were it not for the fact that they are usually waterlogged and thus behave as group D.

The event precipitation total for a particular cell may be found by extracting the value from the IDF layer for a given return period. WCA2D allows definition of multiple precipitation zones within a single simulation, where each zone is defined by its own input file. Each zone covers a discrete spatial area of the model domain and has its own precipitation time series. For each zone, we calculate the precipitation time series by distributing total precipitation across the event duration. In some variations, this may be done according to a design hyetograph, such as the simple triangular hyetograph that starts/ends with a precipitation intensity of 0 and peaks at the midpoint of the precipitation event with an intensity of twice the mean intensity.

Soil infiltration and/or urban drainage may be accounted for to determine the effective precipitation total for the model. In urban areas, the high coverage of impervious surfaces and presence of storm drain networks means that the use of event infiltration totals based on soil type to calculate effective precipitation inputs for the model is inappropriate. Instead, drainage design standards may be based on urban land cover types and density. Standards represent the storm water drainage network capacity to absorb precipitation and associate with total precipitation for a given return period. If a particular urban area has a drainage network capable of absorbing a 10-year precipitation event, the 10-year precipitation total may be extracted from the IDF curves and subtracted from the precipitation total of the simulated event to arrive at the total effective precipitation for the simulation.

In rural areas, a simple Hortonian infiltration model may be used to calculate the appropriate total infiltration for a given precipitation event over a given soil type. The model takes the form:

i=iₛ+(i₀−iₛ)e^{-R/K} EQ N. 13

in which:
i=estimated instantaneous infiltration rate (mm/hr)
iₛ=saturated infiltration rate (mm/hr)
i₀=initial infiltration rate (mm/hr)
R=cumulative precipitation (mm; intensity×time)
K=infiltration rate decay coefficient.

Typical values of K range from 5-20. In some implementations, a value of 10 may be used. In some applications, the model may be implemented by calculating the instantaneous infiltration rate for each timestep of the cumulative precipitation time series. The total volume of water to add to the model domain may then be calculated by subtracting the total infiltration from the total event precipitation to produce the effective precipitation total. The total effective precipitation, estimated by either differencing total soil infiltration or precipitation according to an urban design standard, may be converted back into a time series using the same hyetograph shape as the raw input precipitation time series.

The total effective precipitation, estimated by either differencing total soil infiltration or precipitation according to an urban design standard, may be converted back into a time series using the same hyetograph shape as the raw input precipitation time series. Subsequently, the data for each tile may be split into, for example, about 5000 zones, each of which is approximately 2 km² in area. Although 5000 zones is mentioned, this is done for illustrative purposes only. The number of zone may be greater than or less than 5000. For each zone, the total effective precipitation may be calculated by estimating the following: (1) total precipitation (e.g., from NOAA IDF); (2) dominant soil type (e.g., from SSURGO); (3) total infiltration according to the total precipitation and dominant soil type, which we calculate using a linearly interpolated triangular hyetograph and a simple Hortonian model; (4) surface water runoff design standard by estimating the proportion impervious surfaces (e.g., using the NLCD categories of low, medium, and high development intensity); and (5) total effective precipitation for the flood event, which is the difference of the total precipitation and either the total infiltration (if a zone is rural) or design standard (if a zone is urban/suburban). If more than 20% of land cells have impervious surfaces, the zone may be Deemed (sub)urbanized. Surface water runoff design standards correspond to level of development intensity. For low intensity (suburban) a 1 in 2 flood event design standard may be assigned; for a medium intensity (small city) a 1 in 5 flood event design standard may be assigned; and for a high intensity (large city) a 1 in 10 flood event design standard may be assigned

In some implementations, the total effective precipitation may be used to construct the hyetograph for the CADDIES model. For the six-hour event, the total effective precipitation over three hours may be released and the model may be allowed to run for three additional hours to distribute the water. Alternatively, the effective precipitation over six hours may be dropped and the model allowed to run for another three to six hours. Aside from estimating total effective precipitation, there are a few other parameters to note in the WCA2D model, including slope tolerance, the tolerance parameter, and the roughness (friction) parameter

WCA2D is a diffusive-like model that lacks inertia terms and momentum conservation, meaning that very small-time steps are required to recreate a wave front over very flat terrain. Too high a slope tolerance value reduces the quality of results and too low a value leads to long model run times. In common with diffusive formulations, as the slope tends to zero, the adaptive time-step equation used to determine the appropriate model timestep also tends to zero. The solution to this is to accept a small reduction in model accuracy under such conditions and introduce a tolerance parameter that excludes very shallow slopes from the timestep calculation. This parameter represents the minimum slope value that is considered by the model. By increasing this value, the minimum timestep may be increased and, as a result, model runtimes may be reduced; however, if it is increased too far then instabilities in the model solution may start to arise. An appropriate rule of thumb, as prescribed by the WCA2D manual, is to use a value an order of magnitude less than the average pixel-to-pixel slope percent across the domain. However, after trial and error, a constant value of 1 does not necessarily produce instabilities and reduces model run times drastically in tiles with heavy precipitation and low average slope.

Simply put, the tolerance parameter determines when the model needs to calculate water transfer between cells. This parameter reduces the number of calculations performed per time step by skipping the calculation of flow between two cells where the water surface height difference between the cells is below the tolerance value. Where a flow calculation is skipped no water will flow between the two cells in question, but flow between either cell and their other neighboring cells can still occur (assuming the tolerance value is exceeded in each case). Thus, the water surface height between the two cells in question can still change, and, once the water surface height difference between the two cells exceeds the tolerance value, then flow will be calculated. The result of this is that higher tolerance values result in fewer individual flow calculations but a ‘lumpier’ evolution of flow through the simulation; and, if set too high, then instabilities in the solution may arise. Although testing has indicated suitable values for tolerance may range from 10⁻³ to 10⁻⁴, values of 0.00001 (m) or less may also be used.

Manning's it, the roughness (friction) parameter, is a dimensionless measure of surface friction used to characterize the resistance to flow imparted by the land surface. So long as sensible values are used, model sensitivity to the choice of Manning's n is modest and the uncertainty imparted by it is small relative to other sources. Typical floodplain roughness values range from 0.03-0.1.

There are several post-processing steps to prepare WCA2D model output for risk rating analysis and visual presentation. When simulating large areas that span multiple model domains (‘tiles’), it is important to pay particular attention to the boundaries of each tile to ensure a seamless final dataset where the tile boundaries between individual tiles cannot be identified by the end user as visible model artifacts. Boundary artifacts occur at the edge of individual tiles because the behavior of the model at the edge of a tile should, in many instances, be influenced by processes occurring beyond the edge of the model domain. However, by virtue of being beyond the model domain, these processes are unable to occur. A simple example of this would be to imagine a sudden narrowing of a steeply sided valley just beyond the edge of the model domain. If the model domain extended to cover this constriction, then a simulated flood down the valley would be blocked by the constriction, causing water levels upstream to rise (a phenomenon called backwatering). Since the constriction lies beyond the model domain, the upstream area does not ‘know’ that the downstream constriction exists and, as a result, the backwatering effect may not occur when the flood simulation is performed. In order to handle this problem, the model domain may be extended further than the area of interest to create a ‘buffer’ around the tile, so that these artifacts can play out harmlessly. For deep fluvial floods on large and flat floodplains, these tile buffers should extend as far as 0.25 degree because processes, such as backwatering, can influence model behavior over large distances in extreme cases. For pluvial simulations, a more modest buffer of 0.1 degrees may be sufficient.

The buffers of simulated result tiles may also be overlapped onto adjacent tiles along the adjoining boundary. Once adjoined, a weighted blend may be performed to ensure the tiles fit seamlessly together. This can be done using a simple linear weighting approach, in which the weight of each tile decreases towards its own boundary. For any overlapping pixel the two weights sum to 1. By multiplying each value by its weight, and summing the resulting values, a weighted blend is achieved. For large-scale implementation of the above principle, a routine that loops over the horizontal boundaries of the tile set may be constructed before returning to the first tile and looping over the vertical boundaries of the tile set.

Because a pluvial hydraulic model will add water to every single pixel, the maximum-depth output from any simulation may contain non-zero values for every pixel in the model domain (assuming all pixels are subjected to precipitation inputs). However, most of these depths will be trivial as precipitation that lands on anything but the flattest of terrain will quickly move in a downslope direction before accumulating in the channel network, topographic depressions, or areas of low gradient such as floodplains. Since large scale surface water models are subject to a range of uncertainties (such as error in the topographic data, uncertainty in the precipitation IDF relationships, uncertainty in infiltration characterization, and the like), it is not appropriate to represent extremely low depth values; as doing so conveys an inaccurate characterization of model precision to the end-user. Running the downscale process over every pixel in the domain is unnecessarily expensive. An initial depth threshold of 5 cm may be applied to the model output before executing the downscaling.

Hydraulic models are computationally expensive to run, and that computational cost increases exponentially as horizontal resolution increases. A doubling of resolution yields an approximate order of magnitude increase in computational cost. This is because one pixel becomes four and the maximum model timestep approximately halves, meaning that the model must process twice as many timesteps over four times as many pixels resulting in eight times the number of equations to be solved. However, it is also the case that floodplains tend to have very shallow gradients and that flood water levels vary gradually over space. This means that over short distances it is reasonable to assume that the water surface gradient is constant, and it is, therefore, possible to resample a simulated water surface onto a finer resolution grid using a linear 2D interpolation method so long as the change in resolution is not too extreme (i.e., tens of meters rather than hundreds of meters). The fine resolution water surface can then be differenced from a DEM with the same resolution to create the corresponding depth map. A key assumption underlying the downscaling approach is that the coarse DEM on which the hydraulic model is executed is itself derived from the fine resolution DEM onto which the simulated water surface is subsequently downscaled. This assumption ensures that the water volume on the floodplain will not materially change when the downscaling occurs, as the coarse DEM is effectively a spatially averaged form of the fine resolution DEM.

After downscaling, a depth threshold may be applied to the final output data that approximates the ground-floor height of a building. This depth threshold varies from building to building, but 10-20 cm is a typical range. We threshold the downscaled depths by 10 cm, for a final depth threshold (when including the 5 cm from before) at 15 cm. An exemplary basic process may, therefore, include: (1) remove depths below 5 cm; (2) mask open water; (3) add coarse water depth to coarse DEM to obtain coarse water surface elevation; (4) resample water surface elevation to the same resolution as the high-resolution DEM; (5) subtract high-resolution DEM from resampled water surface elevation to obtain high-resolution water depths; and (6) remove depths below 10 cm.

Finally, before communicating relative flood risk to users, flood depths and probabilities for the occurrence of either a 100-year or a 500-year flood event by 2050, the likely depth of that flood, and the expected annual flood depth may be estimated. More specifically, the flood probability for a return period by 2050 may be calculated using the following formula:

P(floodᵣ²⁰⁵⁰)=1−(1−P(floodᵣ^{annual}))³⁰ EQN. 14

and the flood probability for all return periods by 2050 may be estimated using the equation:

P(flood²⁰⁵⁰)=1−((1−P(floodᵣ_{₁}²⁰⁵⁰))(1−P(floodᵣ_{₂}²⁰⁵⁰)) . . . (1−P(floodᵣ_{ₖ}²⁰⁵⁰))) EQN. 15

The expected depth of a flood by 2050 may be estimated using the equation:

$$E ( {X}^{2050} ) = \sum ( {x}_{{r}_{1}} {c}_{{r}_{1}} , {x}_{{r}_{1}} {c}_{{r}_{1}} , , {x}_{{r}_{k}} {c}_{{r}_{k}} ) / {\sum }_{r = 1}^{k} {c}_{r} \qquad EQN . 16$$

and the expected annual flood depth may be calculated using the equation:

E(X^{annual})=Σ(xᵣ_{₁}cᵣ_{₁},xᵣ_{₁}cᵣ_{₁},xᵣ_{ₖ}cᵣ_{ₖ})/100 EQN. 17

in which equations:
P(floodᵣ²⁰⁵⁰) is the probability of a flood occurring by 2050;
P(floodᵣ^{annual}) is the probability of any flood event occurring by 2050, among k return periods)
E(X²⁰⁵⁰) is the expected depth of any flood event with c occurrence frequency every 100 years; and
E(X^{annual}) is the expected annual depth of flooding.

Mapping ln(E(Xᵢ^{annual})) onto the cumulative distribution function F_{X}(x) and multiplying by 100 to obtain relative risk estimates riskᵢ²⁰⁵⁰ for every property i which we limit in range 10 to 100.

F_{X}(xᵢ)=P(X≤xᵢ) EQN. 18

and

riskᵢ²⁰⁵⁰=P(X≤xᵢ)·100 EQN. 19

in which X is the log transform of the expected annual depth of flooding.

In some implementations, regulatory flood risk may be accounted for by incorporating Flood Insurance Rate Maps (FIRM) produced by the Federal Emergency Management Agency (FEMA) for the National Flood Insurance Program (NFIP). These maps estimate polygonal areas prone to flood risk, as represented by the Special Flood Hazard Areas (SFHA). FIRMs are the flagship U.S. federal standard for assessing flood risk at a property level. If a flood model does not capture flood risk for a parcel but there is risk present on the FIRM, risk may be added according to the FIRM zone and zone subtype.

Many different types of information exist for determining the flood risk of a plot of land. This information comprises the National Flood Hazard Layer (NFHL). Different aspects of the NFHL include flood zone and zone subtype, which determine the quantitative and qualitative flood risk, the type of infrastructure present, the administrative works that determine these risks, and the socio-environmental situation of localized risks according to the hydrologic and built context. In some variations, flood risk from the NFHL may be derived using the flood zone and zone subtype layers. The specifics of these sources may be found in the appendix under ‘FEMA flood risk designation’, such as categories and their associated meanings. The remaining area which does not fall in any of these categories is both unmapped and not included as a relevant feature in the NFHL.

Since FEMA FIRMs do not cover the entire U.S. (about 70% of land and 90% of people), flood risk estimates may be improved with a machine learning flood product. For example, a 100-year binary flood hazard layer produced with the random forest method using the NFHL as training data may be used. The random forest, an ensemble method in machine learning, was trained on FEMA 100-year zones to predict areas of floodplain not yet covered by the same FEMA 100-year data. A random forest model generates a large ensemble of decision trees based on subsets of both the training data and predictor variables to minimize correlation between individual decision trees within the ensemble. The ensemble of decision trees (the forest) predicts outcomes (floodplain cell or not floodplain cell). Each individual tree predicts an outcome (yes or no) and the majority outcome from the forest determines the final predicted outcome.

To generate flood depths from this binary layer, the elevation of the water surface of every wet pixel may be estimated. In a binary flood map, the key predictor of water surface elevation is the terrain elevation along the periphery of an area of wet pixels (i.e., the flood edge). This is because it is reasonable to assume that the flood edge constitutes the final point at which the local terrain elevation is below the local water surface elevation.

Extracting these elevations along the water edge, therefore, provides an estimate of the water surface elevation, and, because floodplain water surface elevations vary gradually, it is, therefore, possible to predict the elevation of the interior of the flooded area using an inverse-distance weighted interpolation from the flood-edge elevations. A simple explanation of the method to estimate these flood depths: (1) Erode binary flood hazard layer by 1 pixel; (2) difference original and eroded flood layers to create mask of flood edge; (3) use flood edge mask to extract flood edge elevations from elevation data; (4) interpolate flood interior pixels; (5) perform monotonicity checks between the 100- and 500-year layers to ensure that the 500-year layer depth is always greater than or equal to the 100-year depth (necessary because, in isolated locations, the differing coverage of the 100-year and 500-year FEMA data, in conjunction with noise in the elevation data, led to instances where this requirement was not always satisfied).

Having described a computer-implemented risk rating method, a system for implementing the method will now be described. In some embodiments, the system 100 for implementing the workflow may include a plurality of user interfaces (“UIs”) 10, a third-party platform(s) 20, and the like, as well as a plurality of processing devices 30a, 30b, 30c, 30d, 30e . . . 30n. In some applications, elements of the system 100 are in electronic communication, e.g., had wired or wirelessly (e.g., via a communication network 40). Although a single communication network is feasible, those of ordinary skill in the art can appreciate that the communication network 40 may, in some implementations, comprise a collection of networks, and is not to be construed as limiting the invention in any way. Moreover, multiple architectural components of the system 100 may belong to the same server hardware. Those of ordinary skill in the art can also appreciate that the platform can be embodied as a single device or as a combination of devices.

The external communication network 40 may include any communication network through which system or network components may exchange data, e.g., the World, Wide Web, the Internet, an intranet, a wide area network (WAN), a local area network (LAN), and so forth. To exchange data via the communication network 40, the platform 20, the UIs 10, and processing devices 30a, 30b, 30c, 30d, 30e . . . 30n may include servers and processing devices that use various methods, protocols, and standards, including, inter alia, Ethernet, TCP/IP, UDP, HTTP, and/or FTP. The servers and processing devices may include a commercially-available processor such as an Intel Core, Motorola PowerPC, MIPS, UltraSPARC, or Hewlett-Packard PA-RISC processor, but also may be any type of processor or controller as many other processors, microprocessors, and controllers are available. There are many examples of processors currently in use, including network appliances, personal computers, workstations, mainframes, networked clients, servers, media servers, application servers, database servers, and web servers. Other examples of processors may include mobile computing devices, such as cellphones, smart phones, Google Glasses, Microsoft HoloLens, tablet computers, laptop computers, personal digital assistants, and network equipment, such as load balancers, routers, and switches.

The platforms 20, UIs 10, and processing devices 30a, 30b, 30c, 30d, 30e . . . 30n may include operating systems that manage at least a portion of the hardware elements included therein. Usually, a processing device or controller executes an operating system which may be, for example, a Windows-based operating system (e.g., Windows 7, Windows 10, Windows 2000 (Windows ME), Windows XP operating systems, and the like, available from the Microsoft Corporation), a MAC OS System X operating system available from Apple Computer, a Linux-based operating system distributions (e.g., the Alpine, Bionic, or Enterprise Linux operating system, available from Red Hat Inc.), Kubernetes available from Google, or a UNIX operating system available from various sources. Many other operating systems may be used, and embodiments are not limited to any particular implementation. Operating systems conventionally may be stored in memory.

The processor or processing device and the operating system together define a processing platform for which application programs in high-level programming languages may be written. These component applications may be executable, intermediate (for example, C−) or interpreted code which communicate over a communication network (for example, the Internet) using a communication protocol (for example, TCP/IP). Similarly, aspects in accordance with the present invention may be implemented using an object-oriented programming language, such as SmallTalk, Java, JavaScript, C++, Ada, .Net Core, C# (C-Sharp), or Python. Other object-oriented programming languages may also be used. Alternatively, functional, scripting, or logical programming languages may be used. For instance, aspects of the system may be implemented using an existing commercial product, such as, for example, Database Management Systems such as SQL Server available from Microsoft of Seattle, Wash., and Oracle Database from Oracle of Redwood Shores, Calif. or integration software such as Web Sphere middleware from IBM of Armonk, N.Y. However, a computer system running, for example, SQL Server may be able to support both aspects in accordance with the present invention and databases for various applications not within the scope of the invention.

The processors or processing devices may also perform functions outside the scope of the invention. In such instances, aspects of the system may be implemented using an existing commercial product, such as, for example, Database Management Systems such as SQL Server available from Microsoft of Seattle, Wash., and Oracle Database (Spatial) from Oracle of Redwood Shores, Calif. or integration software such as Web Sphere middleware from IBM of Armonk, N.Y. However, a computer system running, for example, SQL Server may be able to support both aspects in accordance with the present invention and databases for various applications not within the scope of the invention.

In one or more of the embodiments of the present invention, the processor or processing device is adapted to execute at least one application, algorithm, driver program, and the like, to receive, store, perform mathematical operations on data, and to provide and transmit the data, in their original form and/or, as the data have been manipulated by mathematical operations, to an external communication device for transmission via the communication network. The applications, algorithms, driver programs, and the like that the processor or processing device may process and may execute can be stored in “memory”.

“Memory” may be used for storing programs and data during operation of the platform. “Memory” can be multiple components or elements of a data storage device or, in the alternate, can be stand-alone devices. More particularly, “memory” can include volatile storage, e.g., random access memory (RAM), and/or non-volatile storage, e.g., a read-only memory (ROM). The former may be a relatively high performance, volatile, random access memory such as a dynamic random access memory (DRAM) or static memory (SRAM). Various embodiments in accordance with the present invention may organize “memory” into particularized and, in some cases, unique structures to perform the aspects and functions disclosed herein.

The application, algorithm, driver program, and the like executed by one or more of the processing devices 30a, 30b, 30c, 30d, 30e . . . 30n may require the processing devices 30a, 30b, 30c, 30d, 30e . . . 30n to access one or more databases 50a, 50b, . . . 50n that are in direct communication with the processing devices 30a, 30b, 30c, 30d, 30e . . . 30n (as shown in FIG. 1) or that may be accessed by the processing devices 30a, 30b, 30c, 30d, 30e . . . 30n via the communication network(s) 40.

Exemplary databases for use by a drought hazard risk rating processing device 30a may include, for the purpose of illustration rather than limitation: a CMIP5 climate model database 50a and/or a WaSSI hydro-geologic model database 50b. Exemplary databases for use by a heatwave hazard risk rating processing device 30b may include, for the purpose of illustration rather than limitation: the CMIP5 climate model database 50a, localized constructed analogs (e.g., GCM models) 50c, and precipitation measurements and/or estimates 50d. Exemplary databases for use by a storm hazard risk rating processing device 30c may include, for the purpose of illustration rather than limitation: precipitation measurements and/or estimates 50d. Exemplary databases for use by a wildfire hazard risk rating processing device 30d may include, for the purpose of illustration rather than limitation: the CMIP5 climate model database 50a, MC2 dynamic global vegetation models 50e, U.S. Forest Service data (e.g., CRPS, FLEP4, and so forth) 50f, Monitoring Trends in Burn Severity (“MTBS”) 50g, California wildfire projections (CalAdapt) 50h, National Land Cover database (NLCD) 50i, Exemplary databases for use by a flood risk rating processing device 30e may include: CMIP5 50a, National Oceanic and Atmospheric Administration (NOAA) data and modeling products 50j, National Hurricane Center (NHC) data 50k, and/or surface water model data 50l for the purpose of illustration rather than limitation:

The invention may be embodied in other specific forms without departing from the spirit or essential characteristics thereof. The foregoing embodiments are therefore to be considered in all respects illustrative rather than limiting on the invention described herein. Scope of the invention is thus indicated by the appended claims rather than by the foregoing description, and all changes that come within the meaning and range of equivalency of the claims are intended to be embraced therein.

What is claimed is:

1. A computer-implemented method for estimating a property-level climate risk rating based on a plurality of natural climate hazards, the method comprising:
providing or more computer processing devices programmed to perform operations comprising:
calculating a relative change for a first natural climate hazard from a baseline to a target year;
calculating a relative change for a second natural climate hazard from a baseline to a target year;
normalizing each relative change; and
determining an overall climate risk rating by averaging the climate risk rating of the first and second natural climate hazards.

2. The method as recited in claim 1, wherein the natural climate hazards are selected form the group consisting of: drought, heatwave, wildfire, storm, or flood.

3. The method of claim 1 further comprising:
calculating a relative change for one or more additional natural climate hazards from a baseline to a target year; and
determining an overall climate risk rating by averaging the climate risk rating of the first, second, and one or more additional natural climate hazards.

4. The method of claim 1, wherein normalizing each relative change comprises z-score standardizing a relative change distribution per target year.

5. The method of claim 4 further comprising separating z-scores into a first group comprising non-standardized positive values and into a second group comprising non-standardized negative values.

6. The method of claim 1 further comprising weighting a projected average in each target year.

7. The method of claim 6, wherein weighting comprises using a normalized relative change.

8. The method of claim 1 further comprising map weighting a projected average for each target year to a cumulative function of a year 2050 weighted projected average.

9. The method of claim 1, wherein either the first or the second natural hazard comprises drought, the method further comprising aggregating HUC-8 boundaries when the HUC-8 boundaries cross one another at a location.

10. A system for estimating a property-level climate risk rating based on a plurality of natural climate hazards, the method comprising:
a communication network;
a plurality of databases adapted to communicate via the communication network; and
one or more computer processing devices adapted to communicate via the communication network and programmed to perform operations comprising:
calculating a relative change for a first natural climate hazard from a baseline to a target year;
calculating a relative change for a second natural climate hazard from a baseline to a target year;
normalizing each relative change; and
determining an overall climate risk rating by averaging the climate risk rating of the first and second natural climate hazards.

11. The system of claim 10, wherein the natural climate hazards are selected form the group consisting of: drought, heatwave, wildfire, storm, or flood.

12. The system of claim 10 further comprising:
calculating a relative change for one or more additional natural climate hazards from a baseline to a target year; and
determining an overall climate risk rating by averaging the climate risk rating of the first, second, and one or more additional natural climate hazards.

13. The system of claim 10, wherein normalizing each relative change comprises z-score standardizing a relative change distribution per target year.

14. The system of claim 13 further comprising separating z-scores into a first group comprising non-standardized positive values and into a second group comprising non-standardized negative values.

15. The system of claim 10 further comprising weighting a projected average in each target year.

16. The system of claim 15, wherein weighting comprises using a normalized relative change.

17. The system of claim 10 further comprising map weighting a projected average for each target year to a cumulative function of a year 2050 weighted projected average.

18. The system of claim 10, wherein either the first or the second natural hazard comprises drought, the method further comprising aggregating HUC-8 boundaries when the HUC-8 boundaries cross one another at a location.

19. An article comprising:
a non-transitory computer-readable medium having instructions stored thereon that, when executed by one or more computer processors, cause the computer processors to perform operations comprising:
calculating a relative change for a first natural climate hazard from a baseline to a target year;
calculating a relative change for a second natural climate hazard from a baseline to a target year;
normalizing each relative change; and
determining an overall climate risk rating by averaging the climate risk rating of the first and second natural climate hazards.
